(19) United States
(12) Patent Application Publication
(10) Pub. No.: US 2018/0147868 A1
(43) Pub. Date: May 31, 2018

(54) STAMP SET

(71) Applicant: Taiyotomah Co., Ltd., Osaka (JP)

(72) Inventor: Ikuzo MATSUSHITA, Nara (JP)

(21) Appl. No.: 15/452,790

(22) Filed: Mar. 8, 2017

(30) Foreign Application Priority Data
Nov. 25, 2016 (JP) 2016-005643

(51) Int. Cl. B41K 1/36; B41K 1/02

(52) U.S. Cl. CPC B41K 1/36; B41K 1/02

(57) ABSTRACT

A stamp set is provided which includes a stamp base (11) and a flat plate-like stamp plate (12) having a stamp surface (121) at its one main surface. The stamp plate (12) is fixed to a middle of the stamp base (11). The stamp set further includes a pair of antislip elements (13A, 13B) detachably provided at both sides of the fixed stamp plate (12) on the stamp base (11). Each of the pair of antislip elements (13A, 13B) has an antislip surface (131) at its surface side.

### BACKGROUND OF THE INVENTION

### 1. Technical Field of the Invention

The present invention relates to a stamp set used when stamping a desired imprint on an object, such as a resin film, cloth, leather and resin board, which is likely to slip during the stamping.

### 2. Description of the Related Art

There is a demand for stamping a desired imprint on a material, such as a resin film, cloth, leather and resin board, which is used for various craft products. The surface to be stamped of such a craft material may be soft and thus unstable in its shape or may be formed of a material that is likely to slip, so that the stamped characters may be misaligned or uneven and difficult to be clearly stamped. In this context, the present applicants have previously proposed a stamp which has a stamp surface for stamping the surface of a ball, or a spherical body, and which is characterized in that the middle of the stamp surface is protruded in an arched bridge shape (Patent Document 1: JP2005-14257A).

Patent Document 1: JP2005-14257A

### SUMMARY OF THE INVENTION

In the above stamp of the prior art, the reaction moment to the stamping force acting on the stamp main body is approximately constant during the stamping operation, but the ball may slip due to an undried ink during the stamping operation and the stamped characters may thus be misaligned. This may be problematic.

An object of the present invention is to provide a stamp set that can stamp characters on a surface to be stamped without misalignment of the stamped characters.

The present invention achieves the above object by providing a stamp set that includes a stamp base and a flat plate-like stamp plate having a stamp surface at its one main surface. The stamp plate is fixed to a middle of the stamp base. The stamp set further includes a pair of antislip elements detachably provided at both sides of the fixed stamp plate on the stamp base. Each of the pair of antislip elements has an antislip surface at its surface side.

According to the present invention, when characters are stamped on a surface to be stamped, such as those of a resin film, cloth, leather, resin board and other craft products, which is likely to slip, an ink is applied to the stamp plate in a state in which the antislip elements are detached from the stamp base, and the stamp surface of the stamp plate is pressed to the surface to be stamped, in a state in which the antislip elements each having an antislip surface are attached to the stamp base. Through such an operation, the slip between the stamp surface and the surface to be stamped can be prevented during the stamping operation and the characters can be stamped without misalignment of the stamped characters on the surface.

### BRIEF DESCRIPTION OF DRAWINGS

FIG. 1A is a perspective view illustrating a stamp set according to an embodiment of the present invention;

FIG. 1B is a cross-sectional view along line IB-IB of FIG. 1A;

FIG. 2A is a perspective view illustrating a stamp set according to another embodiment of the present invention;

FIG. 2B is a cross-sectional view along line IIB-IIB of FIG. 2A;

FIG. 3A is a perspective view illustrating a stamp set according to still another embodiment of the present invention;

FIG. 3B is a cross-sectional view along line IIIB-IIIB of FIG. 3A;

FIG. 4A is a perspective view illustrating a stamp set according to yet another embodiment of the present invention; and

FIG. 4B is a cross-sectional view along line IVB-IVB of FIG. 4A.

### DESCRIPTION OF THE PREFERRED EMBODIMENT

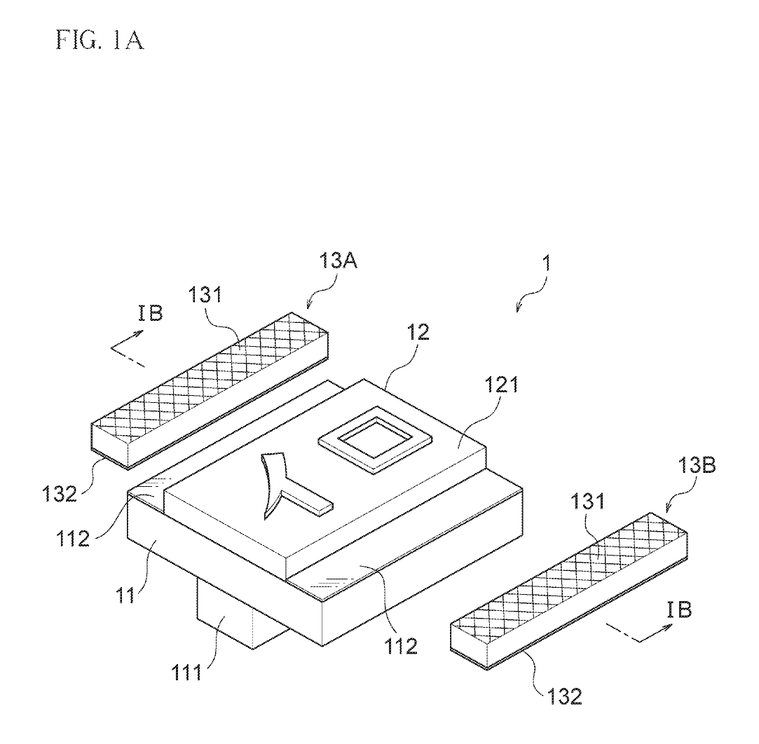

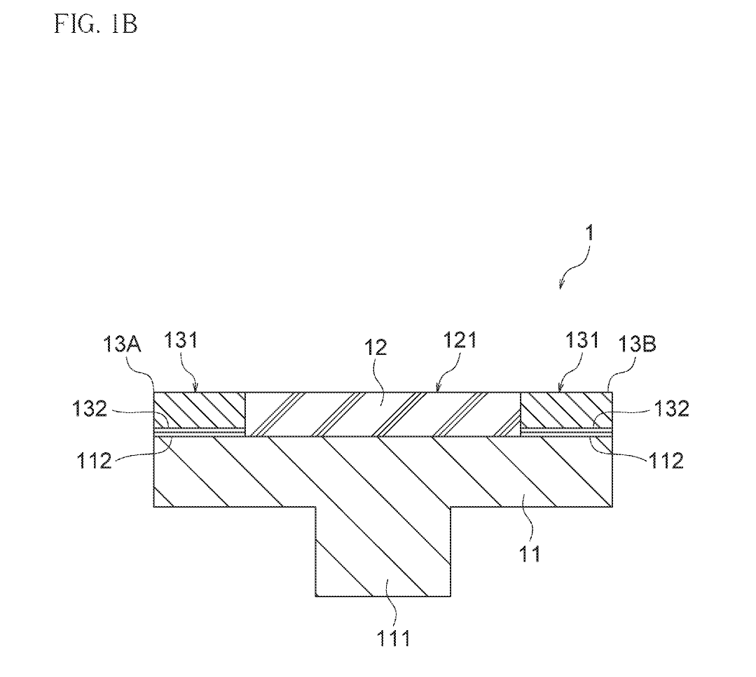

FIG. 1A is a perspective view illustrating a stamp set according to an embodiment of the present invention and FIG. 1B is a cross-sectional view along line IB-IB of FIG. 1A. The stamp set 1 according to an embodiment of the present invention is a stamp or seal used when stamping a desired imprint on a surface of various articles which may be, for example, but are not limited to, various craft products, such as a resin film, cloth, leather and resin board. As illustrated in FIG. 1A and FIG. 1B, the stamp set 1 comprises a stamp base 11, a flat plate-like stamp plate 12 that has a stamp surface 121 at its one main surface and that is fixed to a middle of the stamp base 11, and a pair of antislip elements 13A and 13B that are detachably provided at both sides of the fixed stamp plate 12 on the stamp base 11 and that each have an antislip surface 131 at the surface side.

Imprints to be stamped using the stamp set 1 according to an embodiment of the present invention are not particularly limited and any imprint can be stamped. Examples of such imprints include unique identifiers, such as a name, style, address and phone number, of owners of various craft products and figures and designs of various craft products.

The stamp base 11, which constitutes the stamp set of the present embodiment, is a member for holding the stamp plate 12 and the antislip elements 13A and 13B on one main surface of the stamp base 11. The main surface, which holds the stamp plate 12 and the antislip elements 13A and 13B, is formed as a flat surface and the other main surface is formed, for example, with a handle 111 or the like for gripping the stamp. The stamp base 11 of the present embodiment may be composed of any of a wood material, resin and metal, but may preferably be composed of a wood material or resin because of light weight and low cost.

The stamp plate 12, which constitutes the stamp set 1 of the present embodiment, is formed of a rectangular flat plate having, at its one main surface, a stamp surface 121 for stamping a desired imprint. The stamp plate 12 is composed of a rubber, resin, or other appropriate material. The stamp plate 12 is fixed to the middle of the stamp base 11 by means of an adhesive or other fixing means.

In an preferred embodiment, the stamp plate 12 may be, but is not limited to being, composed of an open-celled porous resin (continuous form-type thermoplastic resin) that is formed by adding a foaming agent to a thermoplastic resin, such as polyethylene, ethylene-vinyl acetate, polyurethane and rubber, and the stamp surface 121 may be impregnated with a quick-drying ink that includes formaldehyde resin, benzyl alcohol, octyl diphenyl phosphate, propylene glycol ethers, glycol ethers, and colorant. A number of craft products are composed of a material that does not absorb an ink, but if an ordinary air-drying ink is used to such a material, the craft product will slip due to the ink and the stamped characters may be misaligned. In the present embodiment, the stamping may be performed using a quick-drying ink thereby to suppress the slip between the stamp surface 121 and a craft product. Moreover, the handling ability after the stamping can be improved because the stamped characters on the surface of the craft product are dried in a short time.

The antislip elements 13A and 13B, which constitute the stamp set 1 of the present embodiment, are each formed as a rectangular flat plate of a material having a certain level of rigidity. The thickness of the antislip elements 13A and 13B is approximately the same as that of the stamp plate 12. Each of the antislip elements 13A and 13B has an antislip surface 131 at one main surface, that is, the surface at the same side as the stamp surface 121 when the antislip elements 13A and 13B are attached to the stamp base 11. The antislip surfaces 131 may be provided such that the antislip elements 13A and 13B as a whole are composed of a material, such as a rubber and elastomer, which has large frictional force to the surface to be stamped of a craft product and the like, or sheets composed of a material, such as a rubber and elastomer, which has large frictional force to the surface to be stamped of a craft product and the like are applied to the surfaces of the antislip elements 13A and 13B. To further enhance the frictional force with the surface to be stamped, the antislip surfaces 131 may be formed with uneven patterns. As will be understood, the material which constitutes the antislip surfaces 131 is not limited to a rubber and elastomer and may also be a wood material or metal, provided that the material has large frictional force with the surface to be stamped.

Rear surfaces of the antislip elements 13A and 13B according to the present embodiment are provided with double-sided tapes 132, which may be double-sided pressure-sensitive adhesive tapes. In response to this, films 112 such as OHP films are applied to the attaching surfaces at the side of the stamp base 11. These films 112 have smooth surfaces and are thus easy to release from an adhesive. This allows the antislip elements 13A and 13B to be easily attached to and detached from the stamp base 11 without the adhesive of the double-sided tapes 132 remaining on the attaching surfaces.

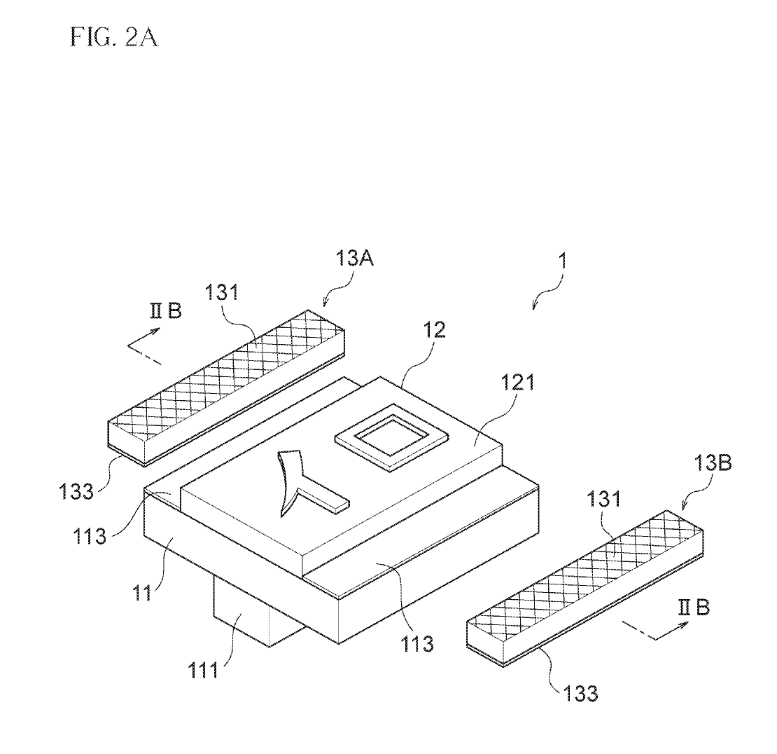

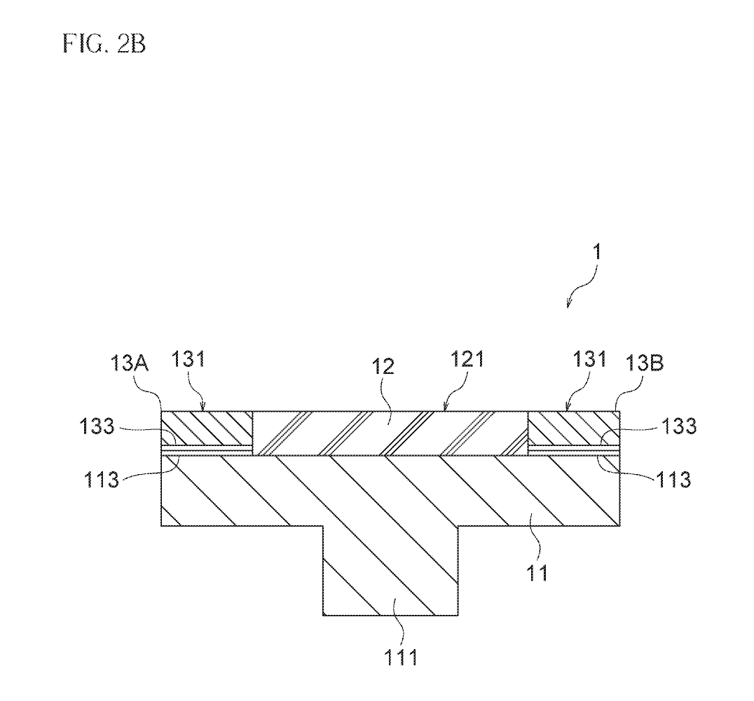

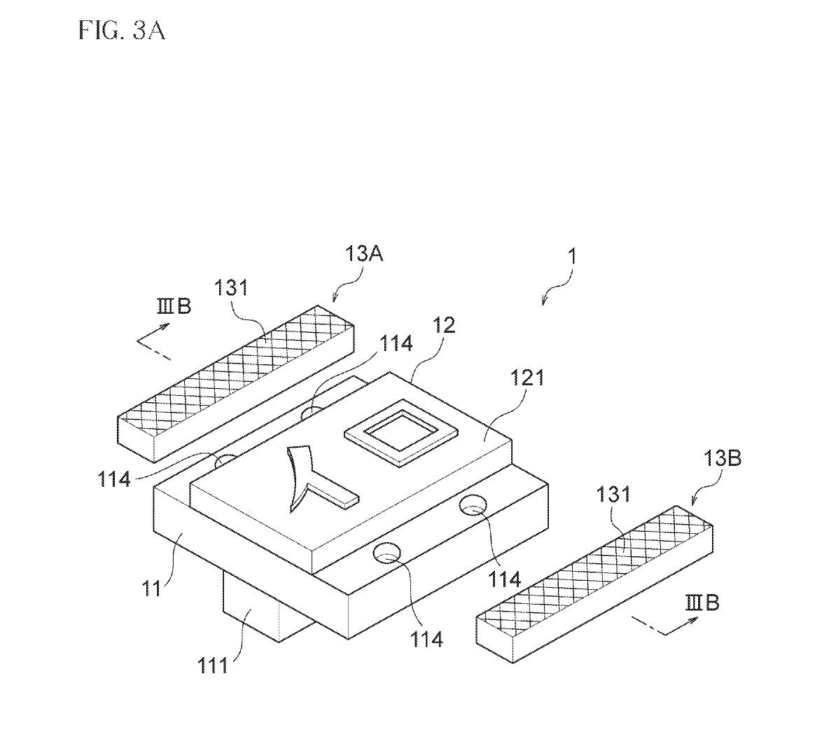

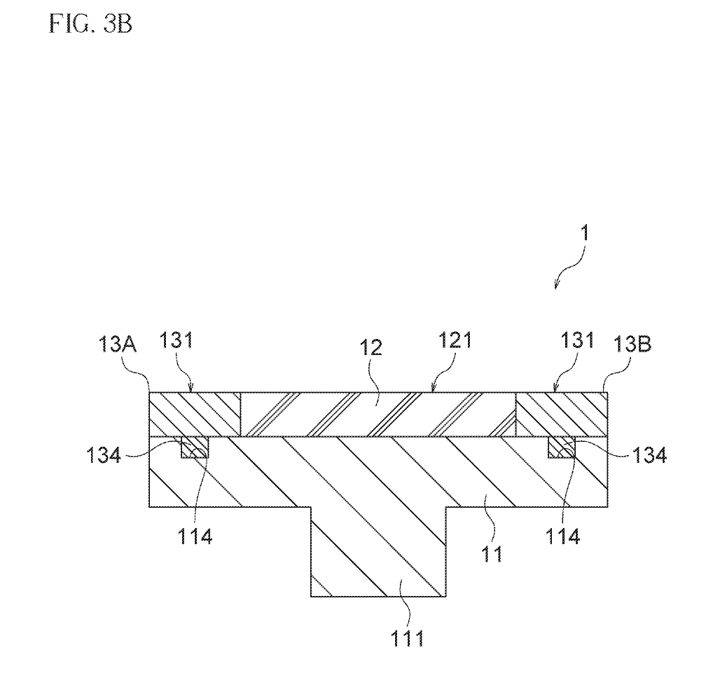

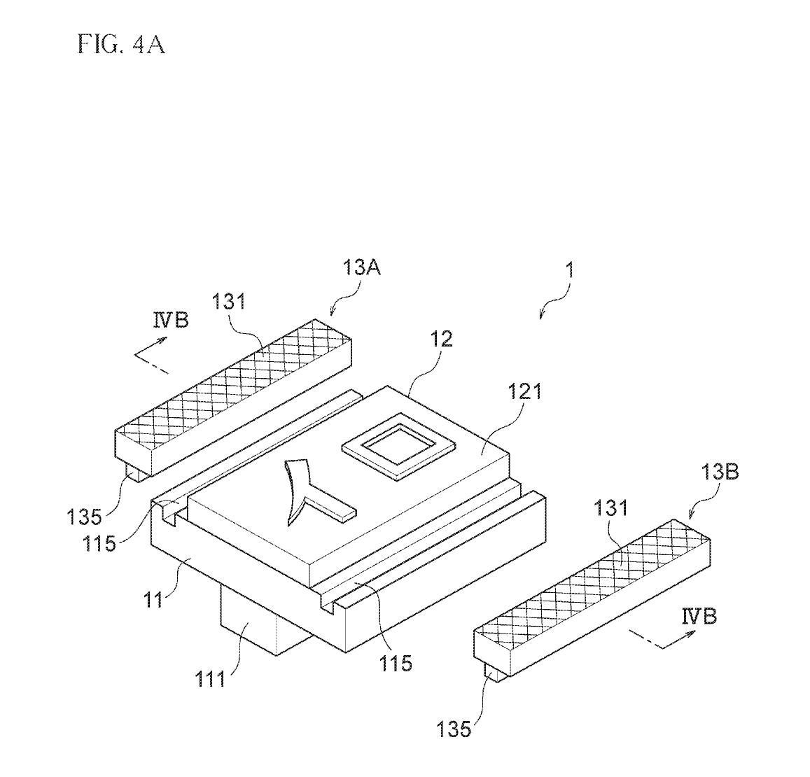

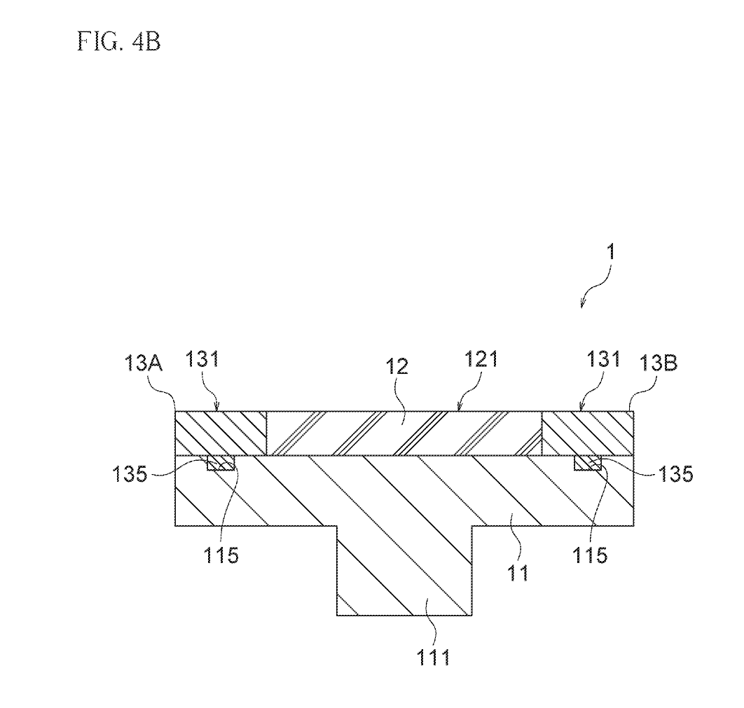

The antislip elements 13A and 13B illustrated in FIG. 1A and FIG. 1B are detachably provided at both sides of the fixed stamp plate 12 on the stamp base 11 by means of the double-sided tapes 132, but the means to detachably provide the antislip elements 13A and 13B on the stamp base 11 is not limited to this. For example, magnetic force is used in the embodiment illustrated in FIG. 2A and FIG. 2B, projection-to-recess fitting is used in the embodiment illustrated in FIG. 3A and FIG. 3B, and slide fitting as one version of the projection-to-recess fitting is used in the embodiment illustrated in FIG. 4A and FIG. 4B.

FIG. 2A is a perspective view illustrating a stamp set 1 according to another embodiment of the present invention and FIG. 2B is a cross-sectional view along line IIB-IIB of FIG. 2A. Magnet sheets 133 are applied to the rear surfaces of the antislip elements 13A and 13B according to the present embodiment. In response to this, magnetic material sheets 113 formed of magnetic material such as metal are applied to the attaching surfaces at the side of the stamp base 11. This allows the antislip elements 13A and 13B to be detachably provided at both sides of the fixed stamp plate 12 on the stamp base 11 by means of the magnetic force. In an alternative embodiment, magnet sheets 133 may be provided at the attaching surfaces at the side of the stamp base 11 while magnetic material sheets 113 formed of magnetic material such as metal may be provided at the rear surfaces of the antislip elements 13A and 13B. In an alternative embodiment, the stamp base 11 itself may be composed of a magnetic material such as metal and magnet sheets 133 may be provided at the rear surfaces of the antislip elements 13A and 13B.

FIG. 3A is a perspective view illustrating a stamp set according to still another embodiment of the present invention and FIG. 3B is a cross-sectional view along line IIIB-IIIB of FIG. 3A. Rear surfaces of the antislip elements 13A and 13B according to the present embodiment are each formed with two projections 134. In response to this, the attaching surfaces at the side of the stamp base 11 are each formed with recesses 114 that are to be fitted with the projections 134. This allows the antislip elements 13A and 13B to be detachably provided at both sides of the fixed stamp plate 12 on the stamp base 11 by means of the projection-to-recess fitting. In an alternative embodiment, the attaching surfaces at the side of the stamp base 11 may be formed with projections while the rear surfaces of the antislip elements 13A and 13B may be formed with recesses that are to be fitted with the projections. To fix the positions of the antislip elements 13A and 13B, it may suffice that at least two projections 134 and two recesses 114 are provided at each side.

FIG. 4A is a perspective view illustrating a stamp set according to yet another embodiment of the present invention and FIG. 4B is a cross-sectional view along line IVB-IVB of FIG. 4A. Rear surfaces of the antislip elements 13A and 13B according to the present embodiment are each formed with a linear projection 135 that elongates in the longitudinal direction. In response to this, the attaching surfaces at the side of the stamp base 11 are each formed with a channel-like recess 115 that is to be fitted with the linear projection 135. This allows the antislip elements 13A and 13B to be detachably provided at both sides of the fixed stamp plate 12 on the stamp base 11 by means of the slide fitting (one version of projection-to-recess fitting) between the linear projections 135 and the channel-like recesses 115. In an alternative embodiment, the attaching surfaces at the side of the stamp base 11 may be formed with linear projections while the rear surfaces of the antislip elements 13A and 13B may be formed with channel-like recesses that are to be fitted with the linear projections. The linear projections 135 and the channel-like recesses 115 may not necessarily have a length that corresponds to the whole of the stamp base 11 in the longitudinal direction and it may suffice that the length is enough to stabilize the positions of the antislip elements 13A and 13B.

A stamping method using the stamp set 1 according to the present invention will now be described.

First, an ink is applied to the stamp surface 121 of the stamp plate 12 in a state in which the antislip elements 13A and 13B are detached from the stamp base 11. This is because the ink should be prevented from attaching to the antislip elements 13A and 13B. After applying the ink to the stamp surface 121 of the stamp plate 12, the antislip elements 13A and 13B are attached to the stamp base 11. Then, the stamp set 1 is gripped to press the stamp surface 121 to an object to be stamped. Through this operation, the whole of the stamp surface 121 is pressed to the surface to be stamped, and desired characters are stamped on the surface to be stamped. During this operation, both sides of the surface to be stamped are pressed to the antislip surfaces 131 at the front surface side of the antislip elements 13A and 13B, and the misalignment between the surface to be stamped and the antislip elements 13A and 13B is prevented. As a result, even when an undried ink is interposed between the surface to be stamped and the stamp surface 121, slip is prevented between the surface to be stamped and the stamp surface 121. As the above, misalignment of the stamped characters due to the relative slip between the surface to be stamped and the stamp plate 12 can be prevented even for the surface to be stamped which is obtained using a material that does not absorb an ink.

### DESCRIPTION OF REFERENCE NUMERALS

1 Stamp set
11 Stamp base
111 Handle
112 Film
113 Magnetic material sheet
114 Recess
115 Channel-like recess
12 Stamp plate
121 Stamp surface
13A, 13B Antislip element
131 Antislip surface
132 Double-sided tape
133 Magnet sheet
134 Projection
135 Linear projection

What is claimed is:

1. A stamp set comprising:
a stamp base;
a flat plate-like stamp plate having a stamp surface at its one main surface, the stamp plate being fixed to a middle of the stamp base; and
a pair of antislip elements detachably provided at both sides of the fixed stamp plate on the stamp base, each of the pair of antislip elements having an antislip surface at its surface side.

2. The stamp set according to claim 1, wherein the pair of antislip elements is detachably provided with respect to the stamp base by means of an adhesive, magnetic force, or projection-to-recess fitting.

3. The stamp set according to claim 1, wherein, when stamping a surface to be stamped of various craft products, such as a resin film, cloth, leather and resin board,
an ink is applied to the stamp plate in a state in which the pair of antislip elements is detached from the stamp base, and
the stamp surface of the stamp plate is pressed to the surface to be stamped in a state in which the pair of antislip elements is attached to the stamp base.

4. The stamp set according to claim 1, wherein, when stamping a surface to be stamped of various craft products, such as a resin film, cloth, leather and resin board,
an ink is applied to the stamp plate in a state in which the pair of antislip elements is detached from the stamp base, and
the stamp surface of the stamp plate is pressed to the surface to be stamped in a state in which the pair of antislip elements is attached to the stamp base.
